(19) United States
(12) Patent Application Publication
(10) Pub. No.: US 2002/0174031 A1
(43) Pub. Date: Nov. 21, 2002

(54) System and method for processing multi-currency transactions at a point of sale

(76) Inventor: Andrew Weiss, Jerusalem (IL)

Correspondence Address: BROWN, RAYSMAN, MILLSTEIN, FELDER & STEINER LLP, 900 THIRD AVENUE, NEW YORK, NY, 10022, US

(21) Appl. No.: 10/092,953

(22) Filed: Mar. 6, 2002

Related U.S. Application Data
(60) Provisional application No. 60/274,044, filed on Mar. 6, 2001.

(51) Int. Cl. G06F 17/60

(52) U.S. Cl. 705/26

(57) ABSTRACT

A system and method are described for supporting non-cash transactions in multiple currencies. The system includes software which determines if a transaction is in a locally processed currency or a non-locally processed currency and proceeds according to such determination. The system also includes a multi-currency payment platform which uses software to interface a point-of-sale terminal with a voucher receiving module and a database system so as to enable the point-of-sale terminal to download current exchange rates for particular currencies. When a cardholder wishes to know the value of the transaction in a particular currency, the point-of-sale terminal provides the cardholder with the exact amount that will be charged in that currency at the time of receipt of the cardholder's statement for the card. The software gives the point-of-sale terminal the capability to recalculate the transaction amount from the currency in which the merchant has priced the transaction (usually the local currency) into the currency of the cardholder's choice, and allows a choice to be made as to the currency in which the transaction will be processed. In addition, the merchant receives settlement in the currency of his choice, which will not necessarily be the merchant's local currency.

### CROSS-REFERENCE TO PRIORITY APPLICATION

Applicant claims the benefit of provisional patent application No. 60/274,044 entitled “SYSTEM AND METHOD FOR PROCESSING MULTI-CURRENCY TRANSACTIONS AT A POINT OF SALE” filed Mar. 6, 2001, which application is hereby incorporated herein by reference in its entirety.

### BACKGROUND OF THE INVENTION

The invention disclosed herein relates generally to a new and improved system and method for enabling non-cash transactions at a point-of-sale to be accomplished in a currency chosen by a cardholder. More particularly, the present invention relates to a new and improved system and method for allowing a cardholder to appreciate, at the time of a purchase, the precise purchase price of an item or service in the cardholder's currency of choice, even if the chosen currency is not otherwise capable of being locally processed.

Existing point-of-sale systems in which a cardholder pays for a purchase using a card allow transactions to be accomplished only in locally processed currencies. Accordingly, if a purchase is made in a locality in which a different currency is used, the cardholder is left with some uncertainty as to the actual price of the purchased item or service in the cardholder's currency. It is not until the cardholder actually receives a statement for the card used that the cardholder knows the exact exchange rate used to determine the cost of purchase. In the case of purchases of significant value (e.g. purchases of jewelry, art, etc.), even a small fluctuation in exchange rate between the date of purchase and the date of processing the transaction in the cardholder's currency could lead to a large differential in the cost of the transaction to the cardholder. Considerable dissatisfaction often results from the cardholder's not knowing at the time of purchase what will be the exact price of the transaction on the statement.

Even after reviewing the periodic billing statement, the cardholder is often confused as to how the transaction amount is derived and is often uncertain as to whether the amount reflects competitive exchange rates or even whether the amount bears any relation to the original transaction. The amount billed for each transaction involves one or more currency conversions/exchanges, and is thus directly impacted by the fluctuation of the exchange rate(s). The cardholder is often charged one or more fees by the card issuer for exchange services for each transaction. The cardholder will often question the amount charged for the transaction as a result of the ensuing exchange rate(s) and the complexity of the periodic billing statement itself.

Even if exchange rates do not fluctuate, the cardholder will not know the exact price until receipt of the periodic billing statement because he/she doesn't know what exchange rates are applied by the card issuer. In addition, the cardholder is further inconvenienced with the need to initiate and follow through on an inquiry with the card issuer or the merchant. In a more extreme case, the cardholder might even initiate a challenge or chargeback of the transaction.

Merchants have problems with the current system as well. Since transactions denominated in a currency other than that of the card are relatively complex for the cardholder to understand, they tend to lead to more frequent cardholder inquiries on the transactions that appear on the cardholder's periodic billing statement as well as cardholder requests for a challenge or chargeback regarding such transactions. A cardholder's challenge or chargeback request is typically made to the card issuer and is directed to the merchant acquirer, and finally to the merchant associated with the specific transaction. If the challenge or chargeback process is directed through the postal service, significant delays can occur in the completion of this process.

The merchant incurs costs for following up on inquiries, challenges and chargebacks. Each challenge or chargeback request requires the merchant's research and response, which impairs the merchant's productivity. Furthermore, if a written request is lost in the mail or delayed in its receipt by the merchant, the merchant might be charged back prior to having the opportunity to respond. In such cases, the merchant is made aware of such a chargeback upon receiving a chargeback notification from the merchant acquirer. Of course, this also impacts the cardholder who might have to undergo a reverse of the chargeback at some later time when the merchant produces satisfactory documentation (e.g. a signed receipt) for the transaction.

The burden imposed by inquiries, challenges and chargebacks for transactions denominated in a currency other than that of the card can subsequently lead to the merchant's dissatisfaction with the merchant acquirer, as well as the cardholder's dissatisfaction with the merchant. Each card association/company monitors the volume of chargebacks, in terms of their percentage of both the total number of transactions and the total monetary amount of those transactions for each merchant. If the percentage of chargebacks exceeds the permissible limit set by the card association/company, the merchant may incur additional monetary penalties on a sliding scale as determined by the card association/company. In addition, the merchant acquirer might increase the merchant's discount rate and require an additional security deposit to guarantee against future chargebacks. In some cases of excess chargebacks, a merchant might lose the ability to process further transactions on the merchant account.

The current system also causes problems relating to card issuers and merchant acquirers. Upon receiving inquiries, challenges or chargeback requests on any transaction, both the card issuer and the merchant acquirer require personnel to handle and monitor each request, typically via a manual process. Even if a simple inquiry does not result in a challenge or chargeback request, the card issuer still incurs a cost for responding to it. Each challenge or chargeback request often requires the card issuer to generate a communication to the merchant acquirer who passes it on to the merchant that handled the transaction.

Card companies/associations are also burdened with the same process to resolve cardholder challenges and chargebacks, as discussed above. Cards have a competitive disadvantage as opposed to payment by cash and checks, for which the exact price is known at the time of transaction.

Third-party card processors are also limited in their ability to offer outsourced point-of-sales services to merchants beyond a particular geographical area, unless they choose to invest in costly hardware and software to enable direct communication with the merchants. With no such communication infrastructure in place, not only must the merchant make a long-distance phone call, but the merchant often waits an unsatisfactory amount of time for the completion of the approval process, thus making the third-party card processor's offering to merchant acquirers residing outside of the third-party card processor's home territory both costly and impractical.

Some of these problems are acknowledged in the prior art. For example, U.K. Patent No. GB 2,319,381 discusses the use of a dedicated system to perform currency conversions. However, this patent fails to disclose a solution compatible with the realities of existing business and finance infrastructure or practice. A practical solution is thus needed to remedy the problems associated with multi-currency transactions as relating to cardholders, merchants, card issuers and merchant acquirers, card companies/associations and third part card processors.

There is a long felt need for a system and method able to perform point-of-sale transactions in a plurality of currencies to eliminate such price uncertainties and to provide numerous other advantages associated with using multiple-currency enabled transactions. The present invention fulfills these needs.

### SUMMARY OF THE INVENTION

It is an object of the present invention to address the above-described deficiencies in the existing point-of-sale systems. One object of the present invention is to provide a point-of-sale terminal enabled to interact with a multi-currency payment platform. As opposed to simply passing standard point-of-sale transaction information, the point-of-sale terminal in the present invention is enabled to download, in real-time, current exchange rates from a merchant acquirer or other financial/foreign exchange service provider. In addition, the point-of-sale terminal is enabled to recalculate the transaction from the local currency (or other currency in which the merchant has priced the transaction) and allows the cardholder/merchant to designate in which currency the transaction will be processed (e.g. the currency in which the card being used in the transaction is denominated).

It is another object of the present invention to facilitate a transaction in which a cardholder will see; an amount on the cardholder's periodic billing statement corresponding to the exact amount that was processed at the time of transaction in the currency of the cardholder's choice and for which the cardholder received a bill or receipt from the merchant. This will reduce the number of inquiries, challenges and chargebacks on such transactions that a cardholder transacts in a currency different from that denominated by the card used and will enhance cardholder satisfaction. In addition, the cardholder will not bear the cost of exchange rate differentials and other costs associated with the translation of currencies, other than what the cardholder signed for, or otherwise assented to, at the time of purchase.

It is another object of the present invention, and an additional benefit, to enable cardholders to expedite the reporting of their expenses based on actual transaction amounts, instead of having to wait for transaction amounts to appear on the periodic billing statement. For example, a business person that is traveling abroad, for example, will be able to receive receipts in the business person's currency of choice, thus expediting his ability to reconcile and submit his/her expense reports required for reimbursement. In addition, a cardholder could also choose to pay in a different currency (e.g. one other than that denominated by the cardholder's card), based on other considerations, such as favorable exchange rates in other currencies. The cardholder could also choose a currency with the most favorable exchange rate with respect to the currency of the cardholder's creditor or bank so as to optimize the economics of the purchase.

This will also reduce the number of inquiries, challenges and chargebacks for such transactions. In turn, this will increase the merchant's productivity or the cardholder's satisfaction with the merchant, and will greatly reduce the merchant's costs to respond to such inquiries, challenges and chargebacks. The cardholder might be more likely to spend in a foreign country since the cardholder will have the comfort of being able to compare prices back home in the same currency, thus benefiting the cardholder and generating more business for the merchant from foreign cardholders.

Embodiments of the current invention also enable third-party card processors to expand their outsourced services to merchant acquirers worldwide in a cost-effective, timely and secured manner without an additional up front investment.

In some embodiments, the present invention provides a system and method that include a multi-currency payment platform which uses software to interface a point-of-sale terminal with a voucher receiving module and a database system so as to enable the point-of-sale terminal to download current exchange rates for particular currencies. Thus, when a cardholder wishes to know the value of the transaction in a particular currency, the point-of-sale terminal will be able to provide the cardholder with the exact amount that will be charged in that currency at the time of receipt of the cardholder's statement for the card. The software gives the point-of-sale terminal the capability to recalculate the transaction amount from the currency in which the merchant has priced the transaction (usually the local currency) into the currency of the cardholder's choice, and allows a choice to be made as to the currency in which the transaction will be processed. In other words, not only will the cardholder know the currency exchange rate and the exact purchase price, but the entire transaction is processed in the cardholder's currency of choice. In addition, the merchant will receive settlement in the currency of his choice, which will not necessarily be the merchant's local currency.

It is noted that although one of the parties involved in transactions is referred to throughout this description as a “merchant”, this term is intended to apply to vendors of things other than goods, such as vendors of services and the like. The present invention thus relates to any type of non-cash transaction having a transactor and transactee (e.g. cardholder and merchant), including by way of example and without limitation, sales, licenses, leases, services, etc. The term “card” is used to encompass any device containing information about a cardholder which is suitable for completing a transaction between a cardholder and merchant and includes but is not limited to credit cards, bank debit cards, travel and entertainment cards, and “smart” cards, which are equipped with magnetic strips or embedded electronics, have memory and are capable of processing information.

In one embodiment, the merchant presents the cardholder with the cost of the transaction in the merchant's favored currency and asks the cardholder whether he or she would prefer to have the bill calculated in a different currency. If the cardholder does choose another currency, the merchant inputs a code into the point-of-sale terminal or selects a symbol on the point-of-sale terminal, which corresponds to the cardholder's choice. The software associated with the point-of-sale terminal then uses the current exchange rate (e.g., the up-to-date exchange rate most recently downloaded to the point-of-sale terminal) between the local currency and the cardholder's currency of choice, and calculates the amount of the transaction in the cardholder's currency of choice. When the cardholder opts to initiate payment for the transaction, the cardholder's card is swiped through the point-of-sale terminal.

The transaction is processed using the selected currency. Such processing involves routing the transaction to a point-of-sale transaction system, where the transaction is logged in, and the appropriate communications between a voucher receiving module, a database system, if indicated, and a local or multi-currency processor are made such that authorization from the card issuer is requested. Examples of voucher receiving modules include delegated modules (such as a geographical module) and acquirer modules. The point-of-sale transaction system tracks the required currency to be settled for the merchant and to be paid by the cardholder. The cardholder is provided with a receipt for the amount of the transaction in the currency that has been chosen. Ultimately, the merchant is paid for the transaction in the currency of the merchant's choice. One feature of the point-of-sale transaction system is a profile for each merchant which, among other things, identifies the merchant's chosen or default currency in which the merchant wants the transactions settled with the merchant's acquirer.

In another embodiment, the invention can optionally be used for local currency point-of-sale transactions as well. That is, the point-of-sale terminal, while giving the cardholder the option of selecting among multiple currencies, does not require the cardholder to exercise this option, such that the transaction can be completed in a default currency of the point-of sale terminal, which most likely will be a local currency.

In another embodiment, the point-of-sale equipment is equipped with an Internet connection, and can be used to perform transactions as described herein by communicating over the corresponding medium.

In some embodiments of the present invention, at least one point-of-sale terminal is connected in a network to one or more voucher receiving modules which are in communication with at least one database system and which each might be in communication with a local processor. Each database system is in communication with at least one multi-currency processor. Both local processors and multi-currency processors are affiliated with acquirers, and are in communication with an automated clearing house that obtains authorization from the issuer of a cardholder's card, such as a credit card or a debit card or the like.

In some embodiments of the invention, a router is used to screen, for example and without limitation, users of the point-of-sale terminals and any merchant web sites communicating with the point-of-sale transaction system to ensure that each is authorized to access the point-of-sale transaction system. The router interfaces between the point-of-sale terminals and the voucher receiving module directly when the point-of-sale terminals are not Internet-enabled, or between modules, the Internet, and the point-of-sale terminals and any merchant web sites when the point-of-sale terminals are Internet-enabled, for example. In a given point-of-sale transaction system according to the invention, both non-Internet-enabled and Internet-enabled point-of-sale terminals can be accommodated through the use of dedicated routers, e.g., the two above-discussed embodiments can effectively be combined.

The system and method according to the present invention may further include features provided to optimize the security and reliability of transaction data transfer among the various components and to carefully limit access to those who have authorization to data about particular cardholder-merchant transactions.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1a is a diagram of a point-of-sale device displaying a value in a local currency, in accordance with an embodiment of the present invention;

FIG. 1b is a diagram of a point-of-sale device displaying a value in a local currency and a value in a cardholder currency, in accordance with an embodiment of the present invention;

FIG. 1c is a diagram of a point-of-sale device of an embodiment of the present information where cardholder information is inputted into a card reader;

FIG. 1d is a diagram of a point-of-sale device of an embodiment of the present invention where a printer prints a receipt for the value in the cardholder-specified currency;

FIG. 2a is a flow diagram showing an authorization process of an embodiment of the present invention;

FIG. 2b is a flow diagram showing an authorization process of another embodiment of the present invention;

FIG. 2c is a flow diagram showing a further embpodiment of an authorization process of the present invention;

FIG. 2d is a flow diagram showing a voucher transaction and payment process of an embodiment of the present invention;

FIG. 3 is a multi-system topology of one embodiment of the present invention;

FIG. 4a is a block diagram of the routing of a transaction in accordance with an embodiment of the present invention;

FIG. 4b is a block diagram of the routing of a transaction in accordance with another embodiment of the present invention;

FIG. 4c is a block diagram of the routing of a transaction in accordance with another embodiment of the present invention;

FIG. 5a is a flowchart illustrating a local currency transaction in accordance with an embodiment of the present invention;

FIG. 5b is a flowchart illustrating a multi-currency transaction in accordance with an embodiment of the present invention;

FIG. 5c is a flowchart illustrating a local currency authorization process in accordance with an embodiment of the present invention utilizing HTTPS form;

FIG. 5d is a flowchart illustrating a multi-currency authorization process in accordance with an embodiment of the present invention utilizing HTTPS form; and

FIG. 6 is a block diagram showing a voucher receiving module configuration in accordance with an embodiment of the present invention.

### DETAILED DESCRIPTION OF THE PREFERRED EMBODIMENTS

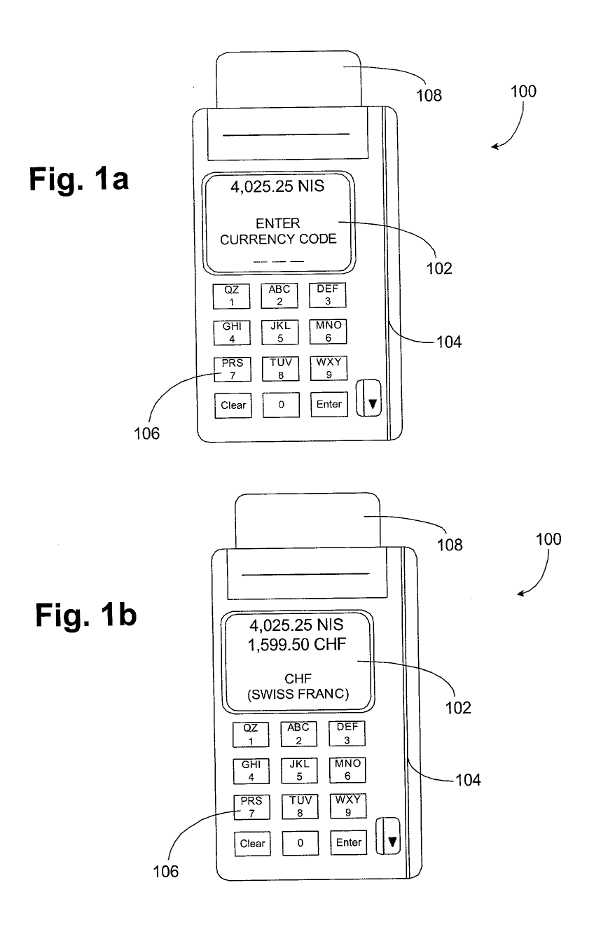

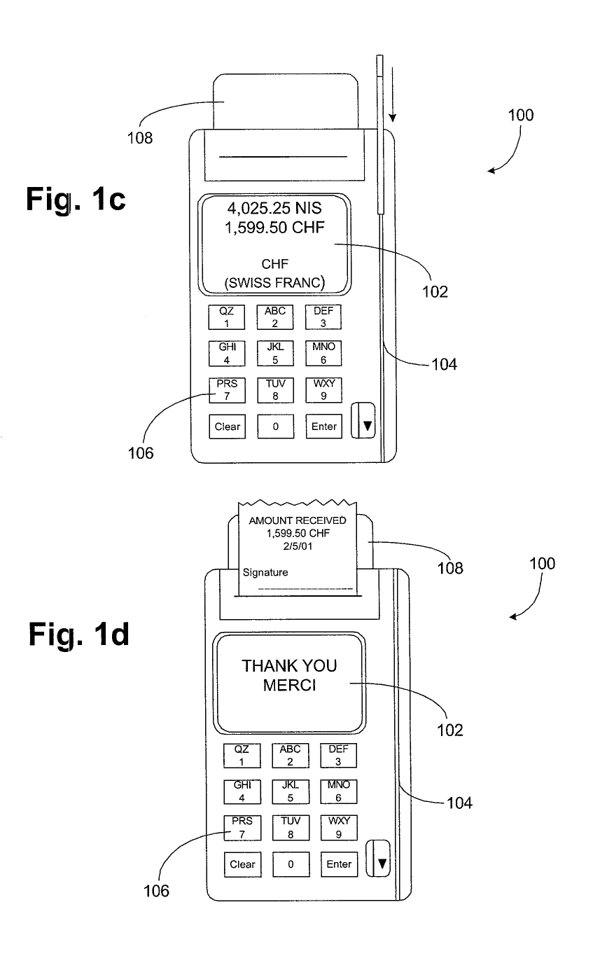

A system and method according to the present invention works with several components. With reference to FIGS. 1a-1d, such components include, in one embodiment, at least one merchant point-of-sale terminal 100, equipped with a display 102, a card reader 104, means to input purchaser or merchant selections or instructions such as a keypad 106, for example, and preferably a printer 108 for providing a receipt and a connection port (not shown), such as by way of example and without limitation a telephone dial-up line, for connecting the point-of-sale terminal to a module site. In addition, a point-of-sale terminal 100 in accordance with embodiments of the invention may be a general purpose computer programmed to perform the functions described herein for the terminal, for use, for example, when a purchase is being made over the Internet.

FIG. 1a shows display 102 displaying a value of a purchase to be made in a first currency, the merchant's local currency for example, in accordance with an embodiment of the present invention. In the present example, the first or merchant currency has been arbitrarily chosen by way of example to be New Israeli Shekels (“NIS”). The keypad 106 or other suitable input device is then used to enter a code corresponding to a second currency, such currency chosen by the cardholder, issuer of the card, or other. FIG. 1b shows display 102 displaying both the value of the purchase in the first currency and its value in a second currency, the cardholder's currency for example, in accordance with an embodiment of the present invention. In the present example, the second or cardholder currency has been arbitrarily chosen by way of example to be Swiss Francs (“CHF”). The value of the first currency and the value of the second currency in accordance with the present invention have an exchange-rate relationship. In FIG. 1c, cardholder information is inputted into a card reader 104 in accordance with an embodiment of the present invention. FIG. 1d shows an embodiment of the present invention where the printer 108 prints a receipt for the value in the second currency.

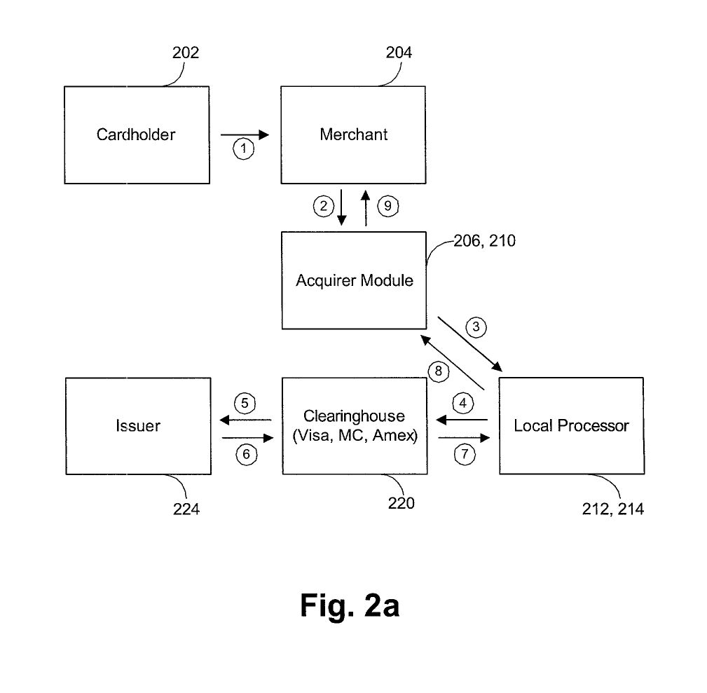

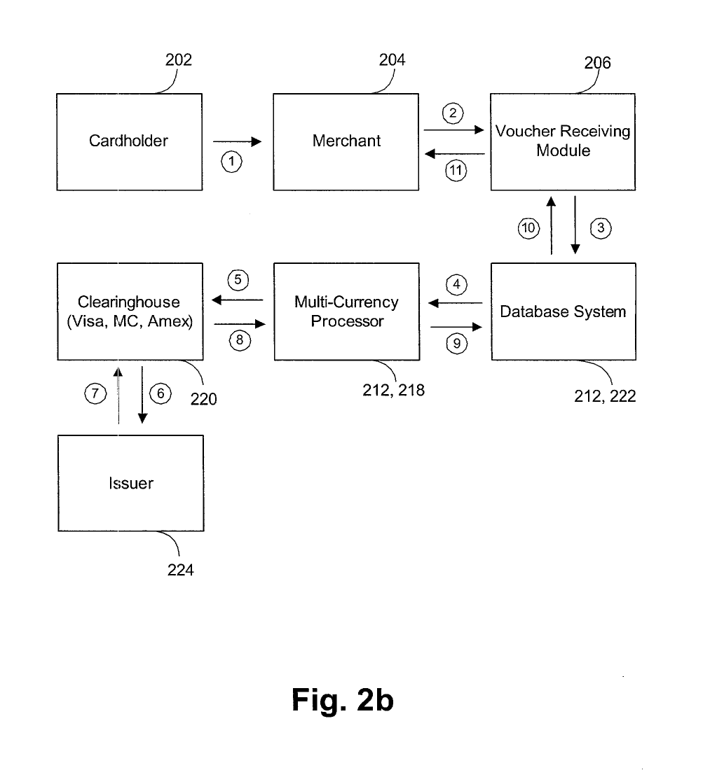

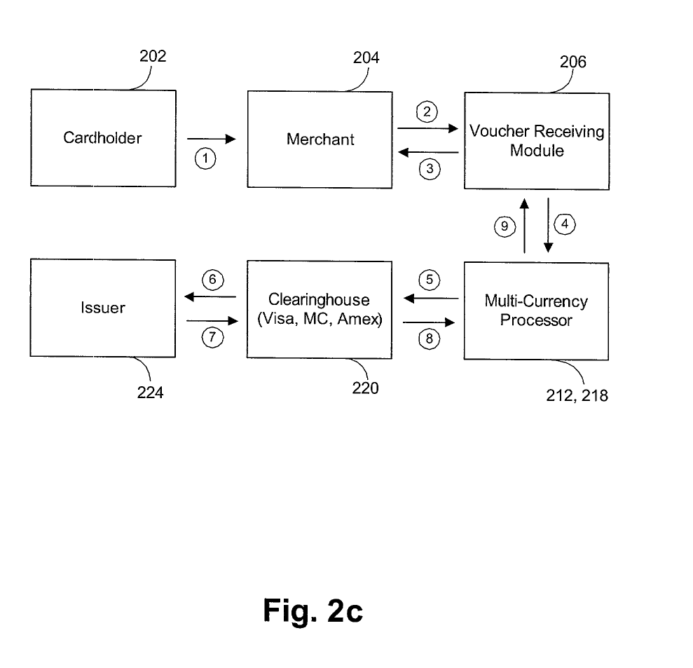

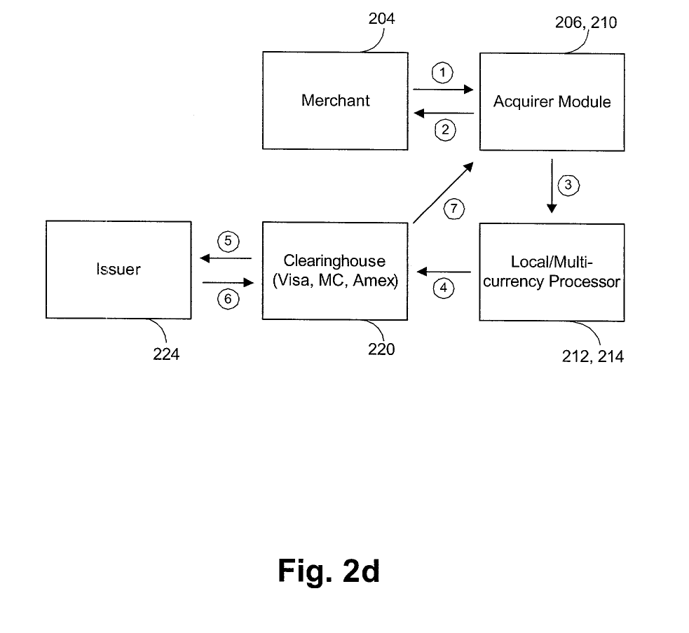

Referring to FIG. 2a, the transaction process for locally processed currency is accompanied by circled numbers indicating the sequence of the transaction flow. The sequence numbers in this and the other drawings represent sequences of events in the particular drawing only; there is no relation among the sequence numbers across drawings. A cardholder 202 first pays a merchant 204 using a credit card or other non-cash payment mechanism. The cardholder 202 and merchant 204 are also sometimes referred to herein as transactor and transactee to a transaction. While one embodiment requires the cardholder 202 to physically present a card upon transacting, alternate embodiments of this invention do not require the cardholder 202 to have actual or constructive possession of a card. To clarify, a cardholder 202 in the broadest sense of its intended meaning herein is an account holder, where such account is for credit, debit, charge, gratis, etc. As discussed further below, some embodiments of the present invention are initiated from the Internet, and some embodiments of such, for example, only require evidence of an account, such as an account number or other appropriate indicia of financial means.

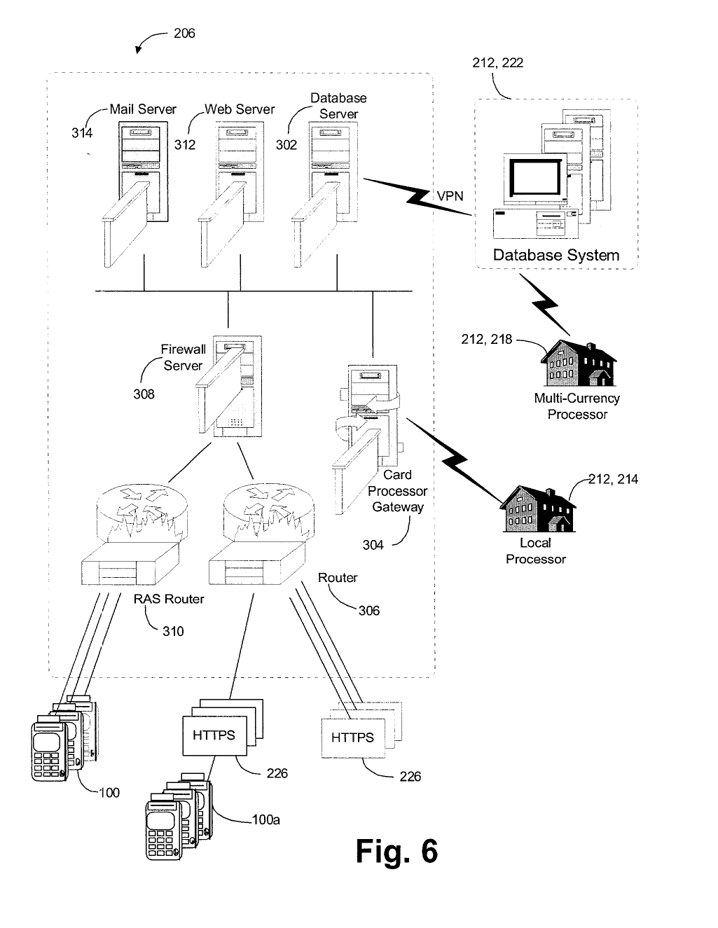

The merchant 204 then forwards vouchers to a module site 206. A module site 206 is referred to herein as a voucher receiving module 206 as it is not a requirement that the components of which the module site comprise all be in one place; is some embodiments, they are distributed. The terms “module site” and “voucher receiving module” encompass various system components which are used to process and store data regarding particular transactions and to protect the security of the transaction data and limit unauthorized access to the module site. Each merchant's transaction enabled point-of-sale terminal 100 is configured to connect to a specific voucher receiving module 206, to which the point-of-sale terminal automatically sends all card transactions that require authorization. The voucher receiving module 206 handles the routing of each authorization request to a card processor system 212 and logs each of the transactions and its authorization status in a database server 302 (see FIG. 6) whose reports are accessible to the merchant 204. The various system components of a voucher receiving module 206 will be discussed further below.

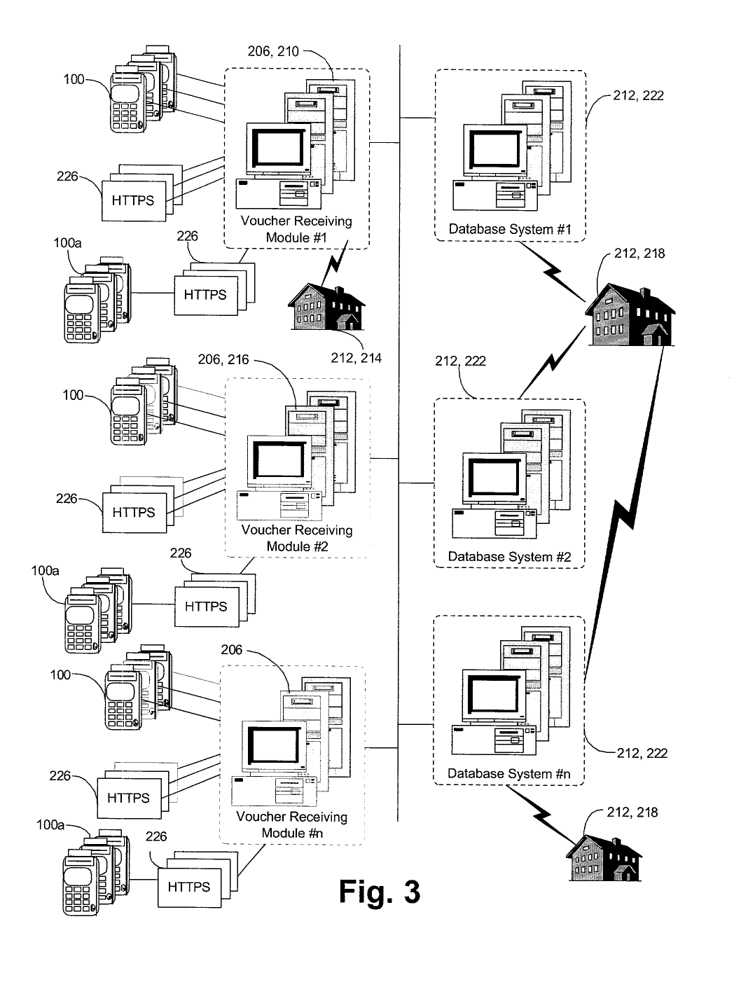

In some embodiments of the present invention, point-of-sale terminals 100 are Internet-enabled (e.g. the point-of-sale terminal 100 has a port through which an Internet connection can be established). If point-of-sale terminals 100 are Internet-enabled point-of-sale terminals 100a (see FIG. 3), the system and method allows data about particular transactions to be communicated with a voucher receiving module 206 via a web site affiliated with the merchant. The merchant web site may or may not be enabled for e-commerce transactions.

Voucher receiving modules 206 as used in connection with the present invention are of at least two types. For example, one type of voucher receiving module 206 is referred to herein as an acquirer module site or an acquirer module 210 and is associated with and usually physically located at a particular acquirer. An acquirer module 210 typically is affiliated with a processing system 212 that is associated with the acquirer where the module site is located, e.g. within the same country or region. The processing system 212 that is associated with the acquirer where the module site is located comprises a local processor 214.

An “acquirer” is an entity that has a business relationship with merchants 204 whereby the acquirer acquires vouchers from the merchants' sales for purchases in which a card is used (a credit card, bank debit card, etc.) and then seeks payment from the issuer of the card. In other words, an acquirer pays the merchant for the vouchers, usually at some discounted rate so as to permit the acquirer to profit from the transaction. Acquirers are business entities, typically banks or other financial institutions, that make arrangements with merchants 204 so as to enable the merchants 204 to accept card payments. An acquirer purchases (“acquires”) the card vouchers collected by a merchant 204 (typically electronic vouchers) at a discount and receives payment from the card issuer 224, typically through a clearinghouse 220. In one embodiment, an acquirer module 210 is located on the physical premises of an acquirer, and services the card transactions of the acquirer's merchants. Each acquirer module 210 preferably has a direct high-speed secured connection to the acquirer's local processor 214.

Referring again to FIG. 2a, the voucher receiving module 206 at the acquirer authorizes payment to the merchant 204 after it receives the voucher. The acquirer deals with the bank that issued the purchaser's card through a local processor 214 and usually through a clearinghouse 220, in order to obtain authorization for payment for the purchaser's transactions with the merchant 204. The issuer 224 receives electronic vouchers forwarded from the voucher receiving module 206, to the local processor 214, and from the clearinghouse 220. In an analogous procedure, the issuer 224 sends “back” payment authorization through the clearinghouse 220 and ultimately to the voucher receiving module 206. This drawing, as in FIGS. 2b and 2c, deals with authorization vouchers rather than payment itself. As exaplined further below, FIG. 2d shows the payment process, in which the local processor 214 gets bypassed when payment travels back to the voucher receiving module 206, although such bypass is not necessary. In any event, the issuer 224 eventually bills the cardholder 202 to collect payment.

In one embodiment, the local processor 214 processes one type of currency, however in alternate embodiments the local processor can process multiple currencies. Such is the case, for example, when there are more than one type of currencies associated with the geographic or national location of the merchant 204.

FIG. 2a shows one embodiment of the authorization process that accompanies, for example, the embodiment of the locally processed transaction. Subsequent to the cardholder 202 swiping the cardholder's card (or otherwise submitting a code for payment, such as over the Internet), an authorization request for the transaction proceeds sequentially from the merchant 204 to the voucher receiving module 206 to the local processor 214, through the clearinghouse 220, and to the issuer 224. If the authorization request is approved by the issuer 224, an authorization confirmation is sent upstream in reverse fashion until authorization confirmation ultimately reaches the merchant 204.

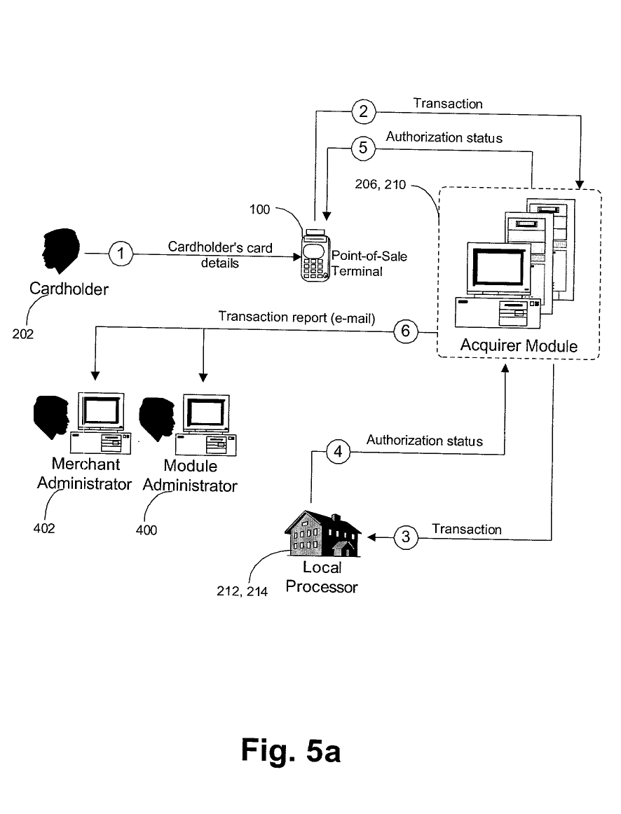

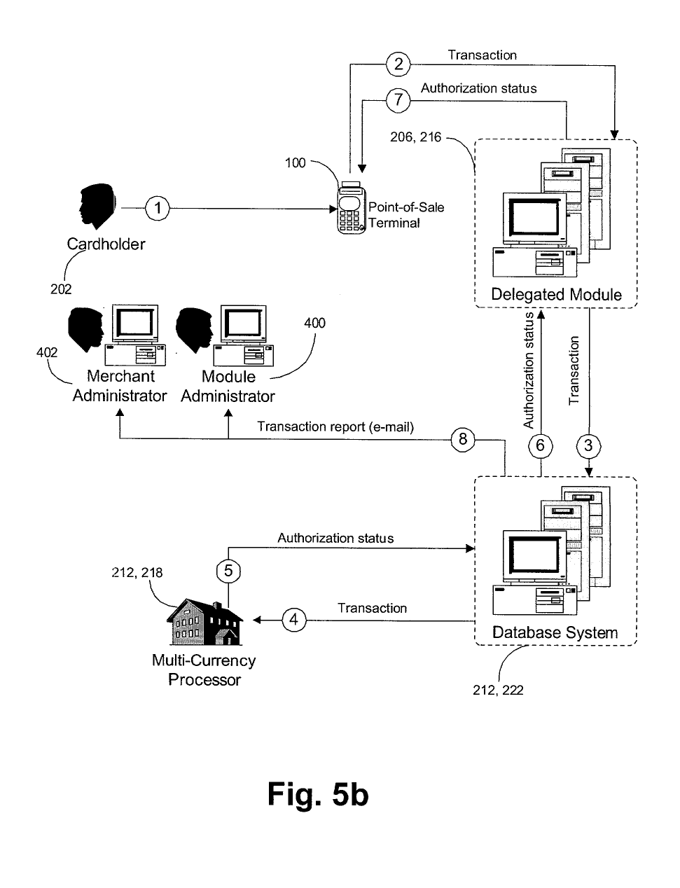

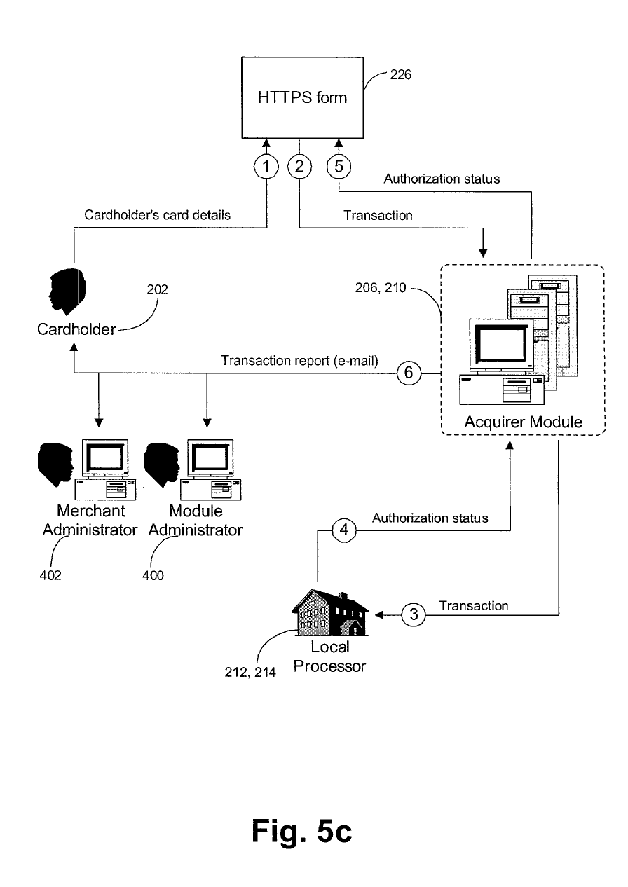

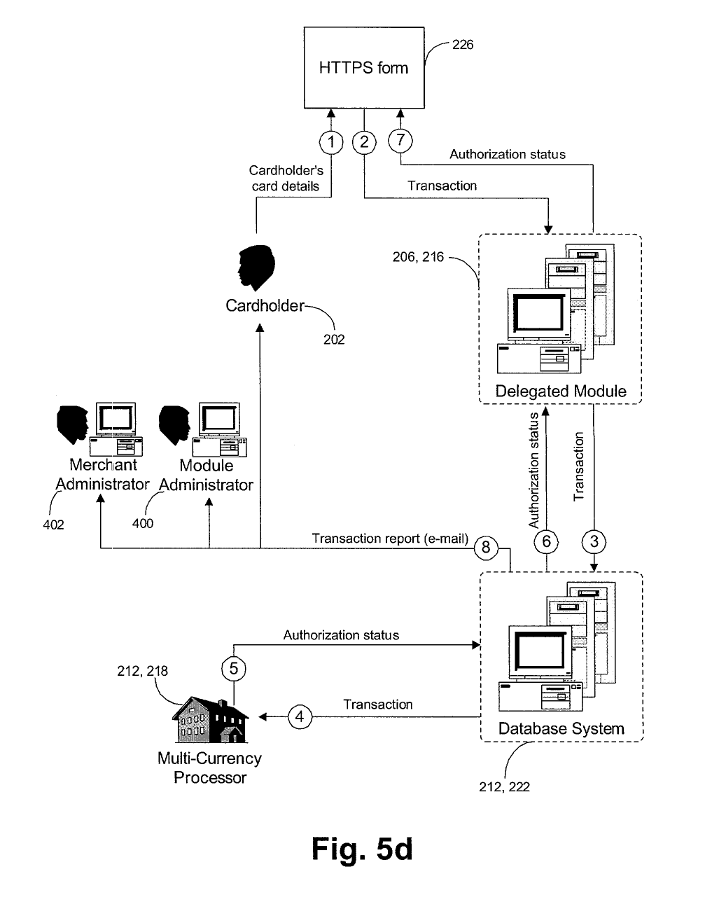

Another type of voucher receiving module 206 is sometimes referred to as a geographical module site and is referenced herein as a delegated module 216 (see, for example, FIG. 5b). This type of voucher receiving module 206 interfaces between multiple acquirers and their merchants 204 that are usually in a particular geographical territory. To clarify, however, the delegated module 216 is not limited to interfacing with acquirers or merchants 204 whom are in proximate geographic location to each other.

A delegated module 216, which is not located at an acquirer's physical premises in some embodiments, services the card transactions of merchants 204 associated with an acquirer which does not have an affiliation with a local processor 214, but rather has an affiliation with a processor outside of the merchants' general locale. In one embodiment, a delegated module 216 is not directly connected to a local processor 214. A delegated module 216 in accordance with the present invention is in communication with a multi-currency processing system 212, comprising, as shown for example in FIG. 2b, a database system 222, which is in communication with a multi-currency processor 218. Thus, in some embodiments, even if a cardholder 202 elects to process a transaction in a merchant's local currency, the transaction will be processed through a database system 222 and a multi-currency processor 218.

The delegated module 216 is associated with a processing system 212, comprising a multi-currency processor 218 and a database system 222. Database system 222 is sometimes referred to as a database center, however a fully centralized database facility is not required. Database system 222 may comprise a centralized database or database center, however it may also comprise a distributed database. The multi-currency processor 218 communicates with the database system 222 and is usually located outside of the locale of the merchants 204 or acquirers that the delegated module 216 services. In one embodiment, the multi-currency processor 218 is capable of both multi-currency and single-currency transaction processing.

In one embodiment, as shown in FIG. 2b, the database system 222 is interfaced between a voucher receiving module 206 and a multi-currency processor 218. The database system 222 is employed whenever a cardholder 202 wishes a transaction to be processed in a currency other than the currency “chosen” by the merchant 204. The merchant's chosen currency is usually the default currency of the point-of-sale terminal 100, however in some embodiments the merchant 204 can specify the currency in which the merchant 204 will be paid. In some embodiments, the multi-currency processing system (comprising at least the multi-currency processor 218 and the database system 222) works with a delegated module 216, however other embodiments will be further discussed below, such as when an acquire module 210 is temporarily non-communicative, for example.

Referring still to FIG. 2b, the authorization process for a multi-currency transaction begins when the cardholder 202 swipes the cardholder's card. Note that the circled numbers are used to indicate the sequence of flow. An authorization request proceeds from the merchant 204 to the voucher receiving module 206, to the database system 222, through the multi-currency processor 218, and, then to the issuer 224 via a clearinghouse 220. If the authorization request is approved by the issuer 224, an authorization confirmation travels in reverse fashion until authorization confirmation ultimately reaches the merchant 204. In the embodiment shown, the voucher receiving module 206 comprises an acquirer module 210. In another embodiment, however, the voucher receiving module comprises a delegated module 216.

Referring to FIG. 2c, the multi-currency transaction process begins when the cardholder 202 swipes the cardholder's card. Vouchers in the foreign currency (e.g., selected by the cardholder 202) are forwarded from the merchant 202 to a voucher receiving module 206 associated with an acquirer(s). The acquirer then settles redemption of the voucher by making payment of the voucher in the merchant's currency of choice to the merchant 202. The foreign currency voucher is then forwarded by the voucher receiving module 206 through the multi-currency processor 218 and to the issuer 224 via a clearinghouse 220. If authorization for the transaction was approved, then the issuer 224 subsequently sends an authorization voucher in the foreign currency to the multi-currency processor 218 via the clearinghouse 220.

It is thus appreciated that embodiments of the present invention differentiate between local processors 214 and multi-currency processors 218. Local processors 214 typically handle card transactions in one or two locally processed currencies (e.g. as offered by the acquirer as per the capabilities of the local processor 214), whereas multi-currency processors 218 service their cardholders 202 by offering a greater selection of international currencies. Furthermore, the multi-currency payment platform determines what type of transaction is present and directs transactions and authorizations accordingly.

In a typical local currency transaction, the cardholder 202 or the merchant 204 swipes the purchaser's card through the card reader 104 of a merchant's point-of-sale terminal 100 to initiate the transaction. Usually, the point-of-sale terminal 100 has a default currency which corresponds to the currency commonly used in the country in which the merchant is located (e.g. U.S. dollars in the United States). If the cardholder 202 is content to have his or her transaction processed in the default or “local” currency specified by the merchant 204, the cardholder's action in swiping the card will result in at least the following:

The point-of-sale terminal 100 will communicate with the voucher receiving module 206 of the merchant's acquirer, which comprises an acquirer module 210 or comprises a delegated module 216, and the cardholder's 202 card information will be transferred, in a secure manner, the system confirming, via a router in the voucher receiving module 206, for example, that the point-of-sale terminal 100 is enabled to access the point-of-sale transaction system. If authorized access by the merchant's point-of-sale terminal 100 is confirmed, the voucher receiving module 206 logs the appropriate information regarding the transaction into a database server 302 (see FIG. 6) of the voucher receiving module 206 and begins to process the transaction to obtain approval for it from the purchaser's card issuer 224.

If the voucher receiving module 206 is affiliated with a local processor 214, such as for example in the case of an acquirer module 210, the voucher receiving module 206 will attempt to communicate information about the transaction derived from the cardholder's card and the merchant's point-of-sale terminal 100 to the local processor 214, which typically is in communication with the issuer 224 of the purchaser's card via a card clearinghouse 220 or the like. If the local processor 214 is communicative (e.g. on-line) at the time the voucher receiving module's communication is attempted, the local processor 214 will accept the transaction data from the acquirer module 210, for example and initiate the appropriate protocol to obtain authorization for the transaction from the cardholder's card issuer 224.

If the local processor obtains authorization from the card issuer 224, the local processor 214 communicates the authorization to the acquirer module 210, whereas the database server 302 of the module site records the authorization, and then the module site communicates the authorization to the merchant's point-of-sale terminal 100 and the transaction, as between the cardholder 202 and the merchant 204 is completed. The point-of-sale terminal 100, if configured with a printer 108, then can provide the cardholder 202 or the merchant 204 with a receipt.

In a “multi-currency” transaction, at the time of purchase, the cardholder 202 opts to select a currency other than the point-of-sale terminal's default currency (e.g. usually the merchant's local currency) in which to process to the transaction. Before swiping the card through the card reader 104 at the point-of-sale terminal 100, the purchaser opts to take advantage of the means provided in the point-of-sale terminal 100 to select a currency of his or her choice in which the transaction will be processed. Such means may be by keypad 106 or by any other suitable means. In some situations, the cardholder 202 might review a plurality of currency choice options provided on the display 102 of the merchant's point-of-sale terminal 100, and the purchaser would select from among these options, which would prompt the point-of-sale terminal software to communicate with the voucher receiving module 206, preferably the delegated module 216, to obtain the current exchange rate between the merchant's desired currency and the local currency and in some embodiments the exchange rate between the merchant's desired currency and the cardholder's desired currency.

Alternatively, if for some reason the voucher receiving module 206, such as the delegated module 216, was non-communicative at the time, the point-of-sale terminal 100 would communicate directly with a database system 222, and the database server 302 of the module site would be updated later by the database system 222 with the details of the transaction. If the voucher receiving nodule 206, which is the delegated module 216 in one embodiment, is active at the time of the transaction, the relevant information about the transaction is logged in and the delegated module 216 communicates with the database system 222 which, in turn, interfaces with a multi-currency processor 218 to process the transaction in the cardholder's chosen currency. The multi-currency processor 218 will interface with the card issuer 224, through a clearinghouse 220 or bank or directly, to seek authorization to complete the transaction. Assuming that authorization is obtained, information identifying the amount of the transaction in the desired currency will be conveyed to the cardholder 202 via the display 102 or a printed receipt via printer 108. An electronic receipt is provided in some embodiments and is further discussed below.

A process of receiving payments on authorized charges is shown in FIG. 2d. The merchant 204 submits (such as at day's end) authorized vouchers to the acquirer 206, which forwards the voucher(s) to the issuer 224 through, in this embodiment, the local or multi-currency processor and clearinghouse 220. The issuer 224 makes payment through the clearinghouse 220, which sends the payment to the acquirer 206, which then forwards the payment on to the merchant 204 or the merchant's bank. In accordance with aspects of the invention, payment is made in the currency chosen by the merchant.

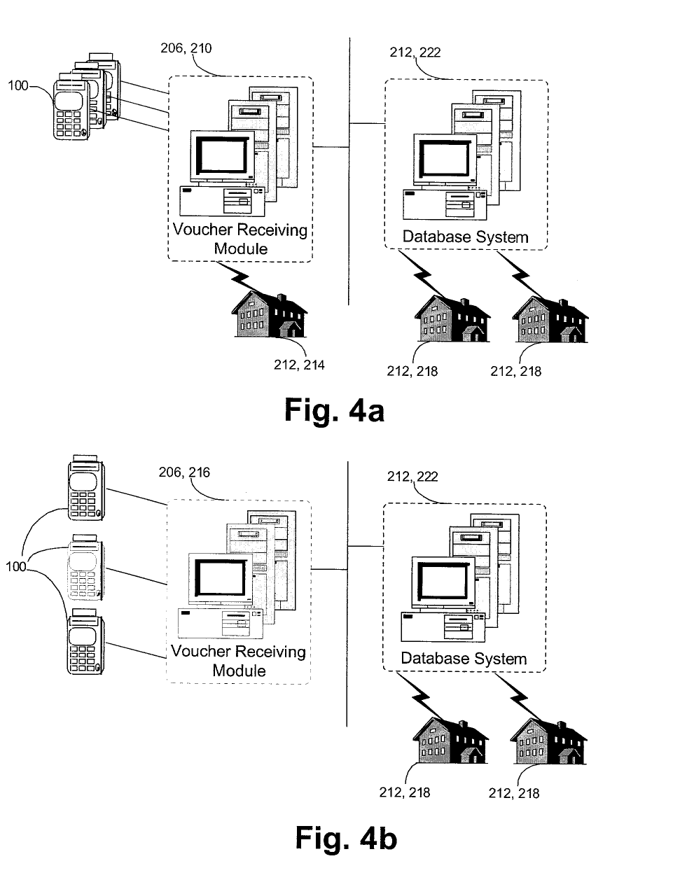

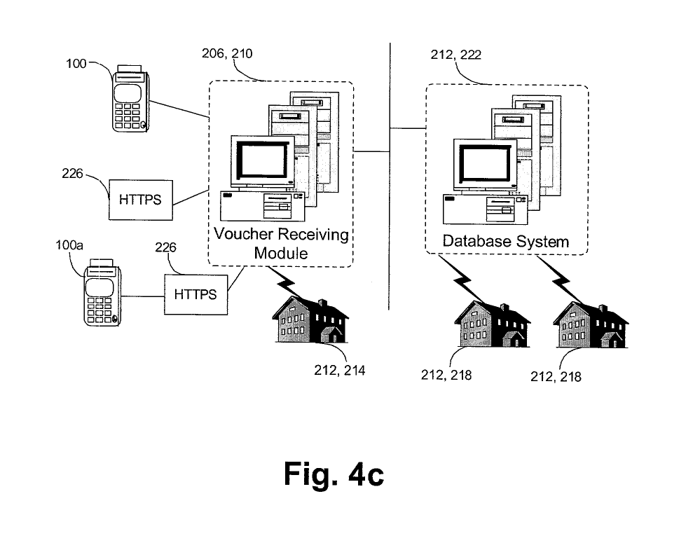

Referring to FIG. 3, there is shown a topology of the system according to the present invention in which it is clear that various combinations of the components of the point-of-sale transaction system can be organized so as to provide interaction between cardholders 202, merchants 204, and multi-currency processors 218, and card issuers 224 in a variety of ways. Various sub-topologies are also depicted in FIGS. 4a-4c for the purpose of example and without limitation. Note that transactions can be initiated by a non-Internet-enabled point-of-sale terminal 100 or an Internet-enabled point-of-sale terminal 100a with HTTPS form 226 for example. It is contemplated that transactions also might be initiated without the use of point-of-sale terminal but rather via a merchant's e-commerce enabled web site with HTTPS form 226.

The voucher receiving modules 206 involved may be dedicated acquirer modules 210 which communicate with both a local processor 214 and, as indicated in some embodiments, with a database system 222 and multi-currency processor 218. Alternatively, the voucher receiving modules 206 may be delegated modules 216, which communicate with a database system 222 and a multi-currency processor 218 regardless of whether a transaction is to be completed in the local currency or in a different currency. Multiple database systems 222 may be securely interconnected to enhance system capacity and to promote system efficiency. In some embodiments, the multiple database systems 222 may comprise a distributed database either alone or in combination.

In some embodiments, a voucher receiving modules 206, at least including delegated modules and acquirer modules 210, communicate with all database systems 222 via a virtual private network (“VPN”), thus enabling transactions to be routed from any voucher receiving module 206 to any multi-currency processor 218 that is connected to a database system 222. Also in some embodiments, each database system 222 is located at a highly secured location, providing a direct, high-speed, secured connection to at least one multi-currency processor 218. Each database system 222 is accessible from all of the voucher receiving modules 206, thus enabling any multi-currency processor 218 to process card transactions for any point-of-sale terminal 100. In a system topology comprising multiple database systems 222, all database systems 222 are connected via high-speed, secured, leased lines.

The database system 222 has a secured, high-speed frame-relay connection directly to at least one multi-currency processor 218, which can process transactions in a selection of international currencies. In some embodiments, each database system 222 is located at a highly secured location and is connected to one multi-currency processor 218, through a frame-relay connection that is backed-up. A database system 222 is adapted to handle the processing of card transactions for any acquirer's merchants 204 (e.g. merchants who use point-of-sale terminals 100 and whose acquirer works with the point-of-sale transaction system). Any voucher receiving module 206 can re-direct its transactions to a database system 222, which will handle the processing of the transactions with a multi-currency processor 218. However, for optimal performance system-wide, the point-of-sale transaction system is configured to automatically route transactions from a specific set of module sites to a specific database system. After handling a transaction (e.g. via a multi-currency processor 218), the database system 222 sends the transaction status information to the merchant's owner module site (e.g., the module site to which the merchant's point-of-sale terminal automatically communicates).

Each database system maintains a database 222 that stores information on all card transactions that are handled system-wide (e.g., for the merchants of all acquirers) even for transactions processed by a local processor 214 directly connected to a voucher receiving module 206. In real-time, the database 222 stores all information on transactions that a voucher receiving module 206 has directed to it (e.g., transactions handled by a multi-currency processor). On a regularly scheduled basis, each voucher receiving module 206 sends the database 222 the aggregate information on those transactions handled by its acquirer's local processor 214 (e.g. transactions not routed through any database system).

In one system topology, with multiple database systems 222, if one database system 222 or its multi-currency processor 218 is unavailable, then its transactions can be routed to another database system 222. In some embodiments, all database systems 222 are connected via high-speed, secured leased lines, through which they can continually synchronize their database systems 222. Since the same transaction information is replicated across all database systems 222, a system-wide management report can be generated from any database system 222.

Each point-of-sale terminal 100 stores currency symbols together with each currency's current exchange rate in relation to the merchant's local currency (e.g., the default currency offered by the merchant 104). In one embodiment, each merchant's point-of-sale terminal 100 downloads the current exchange rates that it requires (e.g., according to the currencies defined in the merchant's profile in the point-of-sale terminal 100) from its voucher receiving module site 206. The download can be accomplished periodically according to a defined schedule (e.g. every 6 hours) or in real time (e.g. whenever an exchange rate is updated).

In some embodiments, a merchant profile contains merchant parameters required for processing transactions, including in various combination, currencies, discount rates, holdback percentages, holdback period, fees and payment period. The merchant profile defines which currencies are locally processed, as well as the settlement currency that is associated with each type of multi-currency available. Local currency transactions are settled in the merchant's local currency. However, for multi-currency transactions, the merchant 204 can specify an alternative currency that might be preferable over the local currency. For example, if a merchant's local currency is Italian Lire, yet the merchant 204 views the Japanese Yen as the preferred currency to be settled when the cardholder 202 chooses to pay in Japanese Yen or in any other non-local currency.

In accordance with the present invention, each voucher receiving module 206 handles the logging and routing of card transactions for a specific set of merchants 204. Referring to the embodiment of FIG. 5a, an acquirer module 210, which may be located at an acquirer's physical premises, services the transactions for that acquirer's merchants 204. An acquirer module 210 has a secured, high-speed frame-relay connection directly to the acquirer's local processor 214. In this embodiment, the cardholder 202 inputs card details into the point-of-sale terminal 100 and transaction information is sent to an acquirer module 210 and the local processor 214. Authorization information and transaction vouchers are obtained in accordance with that generally described above, preferably as described in conjunction with FIGS. 2a-2d, and are forwarded to the point-of-sale terminal 100 via the acquirer module 210 and transaction reports are communicated, preferably via e-mail, to the merchant administrator 402 who may or may not be physically located at the merchant 204 or the voucher receiving module administrator 400 who may or not be physically located at the acquirer module 210.

Referring to the embodiment of FIG. 5b, a delegated module 216 services the merchants 204 of any number of acquirers in a geographical territory, for example. In this embodiment, the cardholder 202 inputs card details into the point-of-sale terminal 100 and transaction information is sent to an delegated module 216 and the processing system 212, first going to a database system 222 and then a multi-currency processor 218. Authorization information and transaction vouchers are obtained in accordance with that generally described above, preferably as described in conjunction with FIGS. 2a-2d, and forwarded to the point-of-sale terminal 100 via the database system 222 and delegated module 216 and transaction reports are communicated, preferably via e-mail, from the database system 222 to the merchant administrator 402 who may or may not be physically located at the merchant 204 or the voucher receiving module administrator 400 who may or not be physically located at the delegated module 216.

Referring to the embodiment of FIG. 5c, an acquirer module 210, which may be located at an acquirer's physical premises, services transactions for that acquirer's merchant HTTPS form 226. Cardholder 202 initiates a transaction relating to HTTPS form 226 either with an Internet-enabled point-of-sale terminal 100a or at a web site. The acquirer module 210 has a secured, high-speed frame-relay connection directly to the acquirer's local processor 214. In this embodiment, the cardholder 202 inputs card details into the Internet-enabled point-of-sale terminal 100a to http or through a web site to http 226 and transaction information is sent to an acquirer module 210 and the local processor 214. Authorization information and transaction vouchers are obtained in accordance with that generally described above, preferably as described in conjunction with FIGS. 2a-2d, and forwarded to HTTPS form 226 via the acquirer module 210 and transaction reports are communicated, preferably via e-mail, to the merchant administrator 402 who may or may not be physically located at the merchant 204 or the voucher receiving module administrator 400 who may or not be physically located at the acquirer module 210 or the cardholder 202 for Internet-initiated transactions which utilized HTTPS form 226.

Referring to the embodiment of FIG. 5d, a delegated module 216 services the merchants 204 associated with HTTPS form 226, for example. In this embodiment, the cardholder 202 inputs card details into one of an Internet-enabled point-of-sale terminal 100a that connects to HTTPS form 226 or an Internet site-related HTTPS form 226. Transaction information is sent to an delegated module 216 and the processing system 212, first going to a database system 222 and then a multi-currency processor 218. Authorization information is obtained in accordance with that generally described above, preferably as described in conjunction with FIGS. 2a-2d, and forwarded to HTTPS form 226 via the database system 222 and delegated module 216 and transaction reports are communicated, preferably via e-mail, from the database system 222 to the merchant administrator 402 who may or may not be physically located at the merchant 204 or the voucher receiving module administrator 400 who may or not be physically located at the delegated module 216 or the cardholder 202 for Internet-initiated transactions which utilized HTTPS form 226.

Each merchant's point-of-sale terminal automatically sends the module site all card transactions that require real-time authorization. The module to which the merchant's point-of-sale terminal directs its transactions, is referred to as the “owner module” as it stores (e.g., “owns”) all information for all of the merchant's transactions handled throughout the point-of-sale transaction system, e.g., regardless of what type of processor (e.g., local or multi-currency) handles the transaction.

Referring to FIG. 6, each voucher receiving module 206 maintains a unique database server 302 which logs the details and authorization status for card transactions. The database server 302 stores information on all transactions handled by the merchants 204 that it services, regardless of whether the transactions are routed to a local processor 214 (e.g. that is directly connected to the acquirer module 210) or to a multi-currency processor 218 (e.g. that is directly connected to a database system 222).

An acquirer module site typically routes authorization requests for transactions denominated in locally processed currency(ies) to the local processor 212, to which it is directly connected. In some embodiments, the delegated module 216 routes all authorization requests to a database system 222, which communicates with a multi-currency processor 218. A transaction may be completed in local currency even via a database system 222 and multi-currency processor 218, such as in the case where an acquirer module 210 is temporarily non-communicative (e.g., off-line). If a multi-currency processor 218 does handle a transaction, the database system 222 to which the multi-currency processor 218 is connected automatically sends the authorization status to the voucher receiving module 206 for logging into the module's database server 302. The voucher receiving module 206 is also used to generate the merchant's management reports and statements. Again, as stated above, each acquirer module 210 and delegated module 216 site can communicate via a VPN with all database systems 222, which are each connected to one or more multi-currency processors 218. The VPN provides an extra security layer through access control, encryption and extensive firewalls.

It will be appreciated that since a point-of-sale transaction download program can reside on the point-of-sale terminal 100 or on the voucher receiving module 206 database server 302, the download process can be initiated by either an administrator 400 associated with a voucher receiving module 206 or a merchant administrator 402. In embodiments where the merchant 204 or merchant administrator 402 initiates the download process, the merchant's digital signature is requested for authentication.

At least one of the database systems 222 periodically (e.g. on a scheduled basis) receives the current exchange rates, which are preferably supplied by an acquirer either via a live link or a file upload. This database system 222 refreshes the exchange rate table stored in its server (not shown). In turn, this database system 222 sends the current exchange rates to all other database systems 222, for updating the exchange rates table stored in each of their respective servers. Each database system 222 sends the current exchange rates to its associated voucher receiving modules 206 for updating the exchange rates table stored on each of their respective database servers 302 (see FIG. 6). The database systems' 222 database servers (not shown) and the voucher receiving modules' 206 database servers 302 typically do not store historical exchange rates. However, for each transaction, the voucher receiving module's 206 database server 302 logs the cardholder's 204 choice of currency, the exchange rate, and the price in the chosen converted currency (e.g. as selected by the cardholder 202) and in the local currency (e.g. as specified by the merchant 204).

The particular components which might be used in a point-of-sale transaction method and system according to the invention may vary. One skilled in the art will recognize the interchangeability of discussed components with others known in the art.

Again referring to FIG. 6, the voucher receiving module 206 preferably includes a router 306, a firewall server 308, a registration authorization server 310 herein also referred to as an RAS router 310, database server 302, card processor gateway 304, a web server 312, and a mail server 314. The card processor 304, router 306, mail server 310, web server 312, and database server 302 are each preferably equipped with firewall options. Router 306 comprises for example and without limitation a Cisco router. These components may each run on separate machines or the same machines.

By way of example and without limitation, the following commercially available components might be installed database systems 222: a backup system, Hot backup for Oracle, local network equipment, Catalyst, routers (including software), spare drives and memory, UPS, secure computer shelf, firewall machine (e.g. Sun systems), encryption hardware, Windows 2000 advanced server, or a paging system.

In some embodiments, and by way of example and without limitation, the following software components might also be installed at the database system 222: anti-virus, Login system, Checkpoint firewall, Linux, Oracle 8I, Windows 2000 advanced server, MSDN library, Oracle library, IP sentry, Paging system, On-line alarm BIOS system, or WAP IL.

By way of example and without limitation, the following commercially available components might be installed at point-of-sale voucher receiving modules 206: backup servers, logic system, or Oracle 8I. A database for logging the transaction details and determining the currency options is configured and designed based on the Oracle database sold by the Oracle Corporation. Oracle databases are kept synchronized by means of inter-site replication.

By way of example and without limitation, the router 306 includes a firewall option, such as a router available from the company Cisco or some other commercially available router. Router 306 is installed at each voucher receiving module 206 and, in some embodiments, the database system 222 also contains a router (not shown). In addition to providing powerful routing functions, the router 306, via its firewall option, provides the level of firewall support throughout the point-of-sale transaction system, so as to protect the entire point-of-sale transaction system from unauthorized access and tampering via the Internet. It will be appreciated, however, that any suitable router may be used.

A firewall server 308 is installed at each voucher receiving module 206 and, in some embodiments, the database system 222 also contains a firewall server (not shown). The firewall server 308, which works in conjunction with the router 306 with the firewall option, for example, provides a second level of firewall support throughout the point of-sale transaction system. The firewall server 308 stores an access control list (“ACL”) which describes the protocols, IP ports and IP addresses that are currently opened for appropriate respondents.

In one embodiment, the firewall server 308 requires the following minimum hardware platform: Intel processor PII-200 or higher PCI architecture, 64 MB RAM, 2 GB hard disk, 100 MB network card, Linux 6.2 and standard “ipchains” daemon supplied with Linux for IP firewalling chains.

In some embodiments, the RAS router 310, which has a multi-port connection device, enables a merchant's point-of-sale terminal to dial-in to a specific connection via an authorized user name and password. The RAS Router 310 also provides for an Internet connection and guarantees secured access, via authentication services that limit access to the point-of-sale transaction system. In one embodiment, a router 306 that is based on Cisco's IOS operating system and that supports IP sec protocols is used.

In some embodiments, a mail server 314 used in accordance with the present invention, automatically e-mails a status report to each e-commerce client that performs a card transaction utilizing the point-of-sale transaction system. A default status report (e.g. that is automatically emailed) can be used, which can be modified by e-merchants, as required. In some embodiments, the mail server 314 has an alarm mail system that is automatically activated in the event of a network failure, power outage or other emergency situation.

In some embodiments, the mail server 314 requires the following minimum hardware platform: Intel processor PII-200 or higher, PCI architecture, 64 MB RAM, 4 GB hard disk and a 100 MB network card. It may also utilize the following software platform: Linux 6.2, “Qmail” service with options for prevention of relay-connections from unauthorized personnel and for protection against spam-relaying, and standard “ipchains” daemon-supplied with Linux for IP firewalling chains.

The web server 312 enables e-merchants to perform transactions via HTTPS 226 and is also accessible for merchants 204, merchant administrators 402, and voucher receiving module administrators 400 to view administration reports. The routing logic is also handled by the web server 312. The web server 312 used in some embodiments requires the following minimum hardware platform: Intel processor PIII-700 or higher, PCI architecture, 356 MB RAM, 9 GB WIDE-SCSI hard disk with mirroring, 100 MB network card. Embodiments of the web server 312 utilize the following software platform: Linux 6.2, Apache web server with a VERISIGN-certified HTTPS connection, Oracle 8.1.5 or 8.1.7 database, and standard “ipchains” daemon-supplied with Linux for IP firewalling chains.

The database server 302 stores transaction data, merchant profile data, and all global system parameters. The database server 302 at a voucher receiving module 206 stores transaction data for the merchants 204 serviced by the module site, whereas the database server at a database system (not shown) stores aggregate data on transactions for all merchants 204 serviced by any voucher receiving module 206. An embodiment of the database server 302 in accordance with the present invention is based upon the following hardware platform: Intel platform and safe wide-SCSI mirroring hard-drives. An embodiment of the database server 302 is based upon the following software platform: Linux 6.2, Apache web-server with a VERISIGN-certified HTTPS connection, Oracle 8.1.5 database (which will be upgraded to Oracle 8.1.7), and standard “ipchains” daemon-supplied with Linux for IP firewalling chains.

In some embodiments, at each voucher receiving module 206, the card processor gateway 304 communicates with a specific card processor. An acquirer module 210 typically communicates with a local card processor (e.g. local processor 214), whereas a database system 222 communicates with one or more multi-currency card processors 218. In some embodiments, 32 the card processor gateway 304 requires the following hardware platform: Intel processor PII-200 or higher, PCI architecture, 64 MB RAM, 2 GB hard disk and 100 MB network card. Some embodiments of the card processor gateway 304 utilize the following software platform: Linux 6.2, high-level physical secure connection to the processor, and local firewall.

In some embodiments, the point-of-sale transaction system utilizes an industry-standard database, communications and security technology technologies. This may include, for example, Cisco VPN security solutions. VPN is an enterprise network deployed on a shared infrastructure employing the same security, management and throughput policies that are applied in a private network. A VPN used in accordance with the present invention supports special protocols, high reliability and extensive scalability, so as to make the system more cost-effective and flexible. VPN can utilize the most pervasive transport technologies available today: the public Internet, service provider IP backbones, as well as service provider of frame relay and ATM networks. The VPN provides an extra security layer through access control, encryption and extensive firewalls. Some embodiments of the point-of-sale transaction may also include Compaq or Sun servers are currently considered of the most scalable, load balanced and reliable servers. Other computers, however, may also be used.

Some embodiments also utilize Unix/Linux. Unix is a powerful computer operating system which is heavily-utilized due to its multi-user and multi-tasking capabilities, flexibility, portability, electronic mail and networking capabilities. In some embodiments, the servers of the present invention are based on Linux, a flavor of Unix, which provides maximum security, availability and compatibility with an existing infrastructure.

In some embodiments, built-in Linux, Checkpoint and Cisco firewalls provide industry standard protection against hackers and support secure per-application access control for IP traffic across perimeters of the networks described herein. They provide the following advanced features: Network level D-o-S detection and prevention to defend networks against SYN flooding and packet injection; Audit Trail to detail connections; real-time alerts to log alerts in case of attacks or other suspicious conditions; basic and advanced traffic filtering; network Address Translation (NAT) for enhanced network privacy by hiding internal addresses from public view; user access controls; and event logging to allow administrators to track potential security breaches.

Some embodiments also comprise additional end-to-end levels of encryption, securing data transmitted across the networks. It will be appreciated by those skilled in the art that the encryption may be by any suitable means, including by way of example and without limitation, 3Des (Triple Des), IPSec, special Cisco secure solutions or other software or hardware encryption standards. In addition, the point-of-sale transaction system is preferably designed with encryption algorithms, database management, and communication protocols. The point-of-sale transaction system uses very strong firewall rules to deny all suspicious connections to the database system and employs a high level of encryption during the transmitting of all information. In addition to the VPN encryption, one embodiment uses an additional encryption protocol to send the data in encrypted format. Some embodiments also use HTTPS protocols in the case of a problem with the voucher receiving module 206 (e.g. in a situation wherein the voucher receiving module is not available) whereupon the merchants 204 will be automatically redirected to a database system 222.

One embodiment of the method of the present invention performed using this system is now described. The point-of-sale terminal 100 requests the purchaser's choice of currency for the transaction. If the purchaser chooses a locally processed currency (e.g. a default currency offered by the merchant, for example), the cardholder 202 is requested to confirm the transaction, based on the price that is displayed on the display 102. If the cardholder 202 does not confirm the transaction, the point-of-sale terminal 100 prompts the cardholder 202 to either select a different currency or to cancel the transaction.

If the purchaser chooses a currency that is not locally processed (e.g. that differs from a default currency offered by the merchant), the point-of-sale terminal 100 recalculates the transaction price based on this currency's most recent exchange rate (e.g. that was most recently downloaded to the terminal) and displays the converted price to the cardholder 202 on the display 102. The cardholder 202 is requested to confirm the transaction, based on the converted price that is displayed on the display 102. If the cardholder 202 does not confirm the transaction, the point-of-sale terminal 100 prompts the cardholder 202 to either select a different currency or to cancel the transaction.

If the purchaser has not canceled the transaction, the purchaser's card is swiped in the card reader 104, which captures the card's details together with the transaction amount in the cardholder 202 choice of currency. The point-of-sale terminal 100 then dials to the module site's RAS router 310, which requests the merchant's authentication. The point-of-sale terminal then sends the encrypted transaction data, and awaits a real-time authorization status response from the module site. If the point-of-sale terminal has an Internet connection, the terminal connects to the module site's web server 312 which requests the merchant's authentication. The point-of-sale terminal then sends the encrypted transaction data, and awaits a real-time authorization status response from the module site. After receiving authorization for the transaction, the point-of-sale terminal 100 prints the purchaser's receipt from the printer 108, which includes the transaction amount in the purchaser's choice of currency and the local currency, if so desired. If the authorization is declined for the transaction, the point-of-sale terminal does not print a receipt.

The transaction flow through the point-of-sale transaction system is as follows. After receiving card data from a cardholder 202, point-of-sale terminal 100 automatically requests the point-of-sale transaction system to authorize the card transaction. In one embodiment, each point-of-sale terminal is configured to automatically route its transactions to a specific voucher receiving module 206 (e.g. either to an acquirer module 210 or to a delegated module 216). The merchant's point-of-sale transaction enabled point-of-sale terminal 100 that sends the transaction to the voucher receiving module 206 can be referred to as an initiating point-of-sale terminal 100. The voucher receiving module 206 to which a point-of-sale terminal 100 directs a merchant transaction can be referred to as the owner module 206a. The owner module 206a stores or owns all information for all of the merchant's transactions, regardless of whether the transactions are handled by the local processor 214 connected to the owner module 206a or by a multi-currency processor 218 connected to a database system 222.

The following steps describe the routing of a transaction between the initiating point-of-sale terminal 100, the owner module 206a and, when required, a database system 222.

A cardholder 202 card is swiped in an initiating point-of-sale terminal 100, which captures the card's details together with the transaction amount in the cardholder's choice of currency. The initiating point-of-sale terminal 100 immediately encrypts transaction data, such as for example and without limitation, the card details, the chosen currency, and the transaction amount in the chosen currency.

If the initiating point-of-sale terminal 100 comprises an Internet-enabled point-of-sale terminal 100a, the terminal connects via HTTPS and SSL to the owner module 206a web server 312 which requests the merchant's digital signature for authentication. The initiating Internet-enabled point-of-sale terminal 100a then sends the encrypted transaction data via HTTPS and SSL, and awaits a real-time authorization status response from the owner module 206a. It will be appreciated that if the owner module 206a is currently unavailable, transactions initiated from an initiating Internet-enabled point-of-sale terminal 100a can be automatically (e.g., with no intervention required) redirected through the VPN to the database system 222 of a multi-currency processing system 212. Transactions directed to the database system 222 will be further discussed below.

If the transaction is not redirected, the initiating point-of-sale terminal 100 dials in to the owner module 206a site's RAS router 310 which requests the merchant's digital signature for authentication. The point-of-sale terminal 100 then sends the encrypted transaction data, and awaits a real-time authorization status response from the owner module site.

The transaction is routed into the owner module 206a, only after going through a sophisticated log-in by the router 306, preferably with a firewall option and access control list, and then through the owner module's firewall server 308. The web server 312 or RAS router 310 sends the transaction to the database server 302, which logs all of the transaction details and preferably concurrently identifies whether the transaction's currency (e.g., as selected by the purchaser) can be processed by the local processor 214.

If the local processor 214 does process this type of currency, the database server 302 reformats the transaction, for example in accordance to the protocol required by the local processor 214, passes it to the card processor gateway 304, and awaits a response. The card processor gateway 304 routes the encrypted transaction through a point-to-point frame relay connection from the card processor gateway 304 to the local processor 214 and awaits a response.

If, however, the local processor 214 does not process this type of currency, the owner module 206a routes the encrypted transaction to a database system 222 and awaits a response. Also, if the local processor is currently unavailable 214 (e.g. is not operational and does not return any status response within a given time duration), the owner module 206a routes the transaction to a database system 222 and awaits a response. Transactions directed to the database system 222 will be further discussed below.

If the local processor 214 returns a pending transaction status response, which response indicates that the local processor 214 is pending a manual verification for authorization, the owner module 206a preferably performs several retries to route the transaction to the local processor 214. If the local processor 214 is still busy, the owner module 206a routes the transaction to a database system 222, and awaits a response.

If and upon receipt of an encrypted status response from the local processor 214 (e.g. via a frame relay connection), the owner module 206a logs the transaction status on the database server 302. Preferably concurrently, and via either the web server 312 which communicates to an initiating Internet-enabled point-of-sale terminal 100a (via HTTPS and SSL), or via the RAS router 310, which communicates with a dialed-in initiating point-of-sale terminal 100, the owner module 206a notifies the initiating point-of-sale terminal 100 of the transaction's authorization status. The mail server 314 e-mails an automatically generated transaction report to at least one of the merchant administrator 402, the voucher receiving module administrator 400, the merchant 204, and the cardholder 202. The routing of the transaction is then completed.

As discussed above, however, the transaction may have been redirected from the owner module to the database system 222 through a VPN (virtual private network) transmission which is automatically encrypted. Such redirect might occur for a number of reasons, including by way of example and not limitations, when the owner module 206a is currently unavailable; when the local processor 214 does not process the type of currency requested by the cardholder 202, or when the local processor 214 is unavailable.

The transaction is routed into the database system 222, only after going through a complicated log-in by the database system's Cisco router (e.g., with the firewall option and access control list) and then through the database system's firewall server (not shown). Upon receipt of an encrypted transaction, the database system logs the transaction details on the database system's database server. Concurrently, the database system 222 routes the encrypted transaction through a point-to-point frame relay connection from the database system's card processor gateway to the multi-currency processor 218, and awaits a response.

Upon receipt of a status response from the multi-currency processor 218, the database system 222 notifies (e.g. via a frame relay connection) the initiating owner module 206a and logs the transaction status on the database server 302 of the owner module 206a. Concurrently, via either the web server 312 which communicates with an initiating Internet-enabled point-of-sale terminal 100a (via HTTPS and SSL) or via the RAS router 310 which communicates with a dialed-in initiating point-of-sale terminal 100, the owner module 206a notifies the initiating point-of-sale terminal 100 of the transaction's authorization status. The database system mail server e-mails an automatically-generated transaction to at least one of the merchant administrator 402, the voucher receiving module administrator 400, the merchant 204, and the cardholder 202. The routing of the transaction is then completed.

In some embodiments, the database system 222 has another feature, namely, a service which periodically scans each voucher receiving module 206 with which it is in communication. If a voucher receiving module 206 was formerly not operational, as soon as it becomes operational, the database system 222 updates the voucher receiving module 206 with the missed transactions.

The present invention thus provides a system and method that includes a multi-currency payment platform which uses software to interface a point-of-sale terminal 100 with a voucher receiving module 206 (e.g. either to an acquirer module 206, 210 or to a delegated module 206, 216) or a database system 222 so as to enable the point-of-sale terminal 100 to download current exchange rates for particular currencies. In addition, the present invention discloses a system and method comprising a multi-currency processing solution compatible with the realities of existing business and finance infrastructure and practice.

When a cardholder 202 chooses to complete a transaction in a particular currency, the point-of-sale terminal 100 will be able to provide the purchaser with the exact amount the cardholder 202 ultimately will be charged in that currency at the time of receipt of the cardholder's credit card statement or bank statement. The software gives the point-of-sale terminal 100 the capability to recalculate the transaction amount from the currency in which the merchant 204 has priced the transaction (usually the local currency), and allows a choice to be made as to the currency in which the transaction will be processed. In other words, not only will the purchaser know the currency exchange rate and the exact price, but the transaction is processed in the cardholder's currency of choice.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for processing a non-cash transaction at a point-of-sale, the method comprising:
receiving a request to process the transaction in a first currency;
determining whether the first currency constitutes a locally processed currency;
if the first currency constitutes a locally processed currency, processing the transaction through a local processor; and
if the first currency does not constitute a locally processed currency, processing the transaction through a multi-currency processor in communication with one or more authorization modules from which authorizations are received for transacting in one or more currencies other than locally processed currencies.

2. The method of claim 1, wherein receiving a request comprises receiving a request from a customer.

3. The method of claim 1, wherein receiving a request comprises receiving a request from a merchant.

4. The method of claim 1, wherein determining whether the first currency constitutes a locally processed currency comprises comparing the first currency to one or more stored currencies which may be locally processed.

5. The method of claim 1, comprising, if the first currency is not a locally processed currency, retrieving stored exchange-rate information and determining a value of the transaction in a locally processed currency.

6. The method of claim 5, comprising displaying the transaction value in the locally processed currency in a point-of-sale device.

7. A system for processing non-cash transactions in multiple currencies, the system comprising:
a point-of-sale device for receiving a request for processing a transaction in a first currency;
means coupled to the point-of-sale device for determining whether the first currency constitutes a locally processed currency;
a local processor for processing transactions in locally processed currency; and
a multi-currency processor gateway for processing transactions in non-locally processed currencies, the gateway comprising a database storing currency exchange-rate and means for communicating with one or more authorizers to obtain authorization to process the transaction in the first currency.

8. A method for facilitating a non-cash transaction in a first currency at a point-of-sale, the first currency comprising a currency other than a local currency, the method comprising:
a merchant selecting a second currency in which to receive payment;
directing a voucher for a value of the transaction in the first currency to a voucher receiving module;
receiving at a multi-currency processor system from the voucher receiving module the voucher for the value in the first currency;
receiving at the multi-currency processor system a voucher authorization for the value in the first currency; and
sending payment for the merchant in a value in the second currency.

9. The method of claim 8, where the second currency and the local currency are the same currency.

10. The method of claim 8, where the value in the first currency has a current exchange-rate relationship with the value in the second currency.

11. The method of claim 8, where the first currency is chosen by a cardholder associated with the non-cash transaction.
